(19) United States
(12) Patent Application Publication
(10) Pub. No.: US 2002/0174822 A1
(43) Pub. Date: Nov. 28, 2002

(54) Vehicle position indicator and method of installing same

(76) Inventor: Carlos Royal, La Costa, CA (US)

Correspondence Address: Foley & Lardner, 402 West Broadway, Suite 2300, San Diego, CA, 92101-3542, US

(21) Appl. No.: 09/804,651

(22) Filed: Mar. 12, 2001

(51) Int. Cl. G08B 5/00

(52) U.S. Cl. 116/28 R; 33/645

(57) ABSTRACT

A vehicle position indicator includes one or more members defining at least two indicating zones disposed in the user's field of view for citing an external reference to facilitate the determining the position of the vehicle relative to the external reference. The vehicle can be guided in a desired path of travel relative to the reference. The member includes at least one indicia separating the zones, and the number is adapted to be fixed to a portion of the vehicle, such as the windshield or dash board, in front of the user.

### BACKGROUND OF THE INVENTION

A. Field of the Invention

The present invention relates in general to a vehicle position indicator and a method of installing it. The vehicle position indicator and installation method more particularly relates to techniques for improving driving safety for vehicles.

B. Description of the Related Art

The operation of vehicles, especially at high rates of speed, can often times be dangerous to the user and other vehicles in the vicinity, especially in inclement weather conditions, when the vehicle does not remain in the lane of traffic. Such problems are particularly aggravated when there are large vehicles, such as recreational vehicles and large trucks which can veer inadvertently over into an adjacent lane of oncoming traffic. Also, it could cause severe injuries and damage to the vehicle by the vehicle veering in the opposite direction off of the roadway and onto a shoulder or other road hazard.

Therefore, it would be highly desirable to have a new and improved driving aid to assist the driver of the vehicle to maintain the proper or desired position of the vehicle in the lane for safety purposes. Thus, the vehicle is more likely to maintain a desired position relative to the roadway. Such a technique should be relatively inexpensive to manufacture. The present invention provides an inexpensive driving aid that addresses these problems.

### SUMMARY OF THE INVENTION

A vehicle position indicator includes one or more members defining at least two indicating zones disposed in the user's field of view for citing an external reference to facilitate the determining the position of the vehicle relative to the external reference.

The vehicle can be guided in a desired path of travel relative to the reference. The member includes at least one indicia separating the zones, and the number is adapted to be fixed to a portion of the vehicle, such as the windshield or dash board, in front of the user.

### BRIEF DESCRIPTION OF THE DRAWINGS

The above-mentioned and other objects and features of this invention and the manner of attaining them will become apparent, and the invention itself will be best understood by reference to the following description of the embodiments of the invention in conjunction with the accompanying drawings, wherein:

FIG. 1 is a pictorial view of the vehicle position indicators, which are constructed in accordance with the present invention and which are mounted on the inside of a vehicle;

FIG. 2 is a diagrammatic view of the indicators of FIG. 1;

FIGS. 3, 4, 5 and 6 illustrate the method of installing the indicators of FIG. 1;

FIG. 7 is a diagrammatic view of an indicator kit, which is constructed in accordance with the present invention;

FIG. 8 is a diagrammatic view illustrating the operation of the indicator of FIG. 7;

FIG. 9 is a diagram illustrating the method for installing the indicators of FIG. 7;

FIG. 10 is a graph illustrating the principal of operation of the indicators of the present invention; and

FIG. 11 is a diagrammatic view of another vehicle position indicators, which are also constructed in accordance with the present invention.

### DETAILED DESCRIPTION OF SPECIFIC EMBODIMENTS

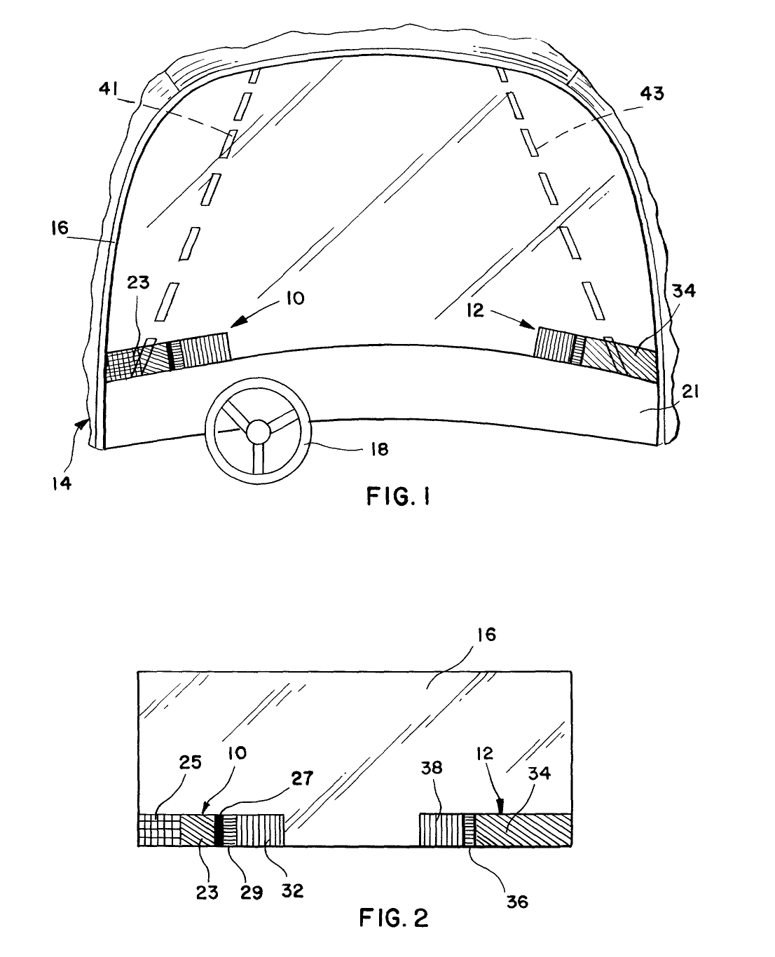

Referring now to FIGS. 1, 2, and 3, there is shown a pair of vehicle position indicators 10 and 12, which are constructed in accordance with the present invention and which are mounted within a vehicle 14 on the windshield 16 on opposite sides of a steering wheel 18 above the dashboard 21.

Considering now the vehicle position indicator 10, the indicator 10 comprises a series of five transparent colored sheets 23, 25, 27, 29 and 32 arranged in a side by side configuration. Each sheet has a different color as indicated in the drawings to determine different zones as hereinafter described in greater detail.

The vehicle position indicator 12 comprises three adjacent colored transparent sheets 34, 36 and 38 arranged in a side-by-side configuration on the passenger side of the vehicle on the windshield 16 adjacent to the dashboard 21. The colors may be as indicated in the drawings. However, it will be understood by those skilled in the art that other colors may also be employed.

In operation, as shown in FIG. 1, the driver of the vehicle positioned behind the steering wheel 18 visualizes a left lane marker 41 which serves as an external reference through the indicator 10. If the driver is able to see the external reference in alignment with the green sheet 23, then the driver is able to know or determine the relative position of the vehicle 14 as being safely within the lane defined by the left-hand lane marker 41 and a right-hand lane marker 43. In general, the position of the lane marker 41 can be aligned with any one of the five sheets to determine in a relatively precise manner the position of the vehicle relative to the lane markers 41 and 43.

Similarly, the passenger's vehicle position indicator 12 can be visualized by a passenger seated on the right-hand side of the vehicle by viewing the right-hand lane marker 43 serving as an external reference through the indicator 12. As illustrated in FIG. 1, the marker 43 is visualized or sighted through the green sheet 34. In general, depending upon the position of the vehicle 14, the passenger could sight or visualize the right-hand lane marker 43 through any one of the three sheets to determine the relative position of the vehicle 14 on the roadway. In this manner, should the driver lose attention relative to the position of the vehicle, the passenger can readily determine whether or not the vehicle 14 is moving out of its lane and thus be able to advise the driver as to the unsafe or undesirable movement of the vehicle. Thus, the driver is able to guide the vehicle in a desired path of travel relative to the external reference such as the lane markers.

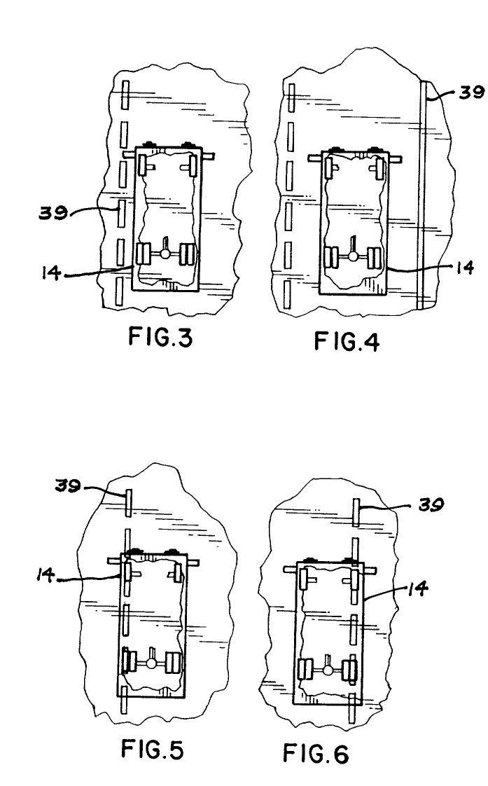

Referring now to FIGS. 3 through 6, there is shown a method of installing the indicators 10 and 12. The vehicle 14 is first parked adjacent to and parallel to a desired external reference, such as a parking lot spacing marker or line 39. In this regard, the vehicle is moved as indicated in FIG. 3, to a position very closely spaced relative to the line 39. A mark can then be placed on the inside of the windshield, for example. The following procedure illustrates this in greater detail:

1. Line the vehicle up so that the driver side of the vehicle lines up with a line (Position 1, illustrated in FIG. 3). This can be a line on the pavement in a parking lot or a rope extended for your vehicle. Once the vehicle is lined up, sit in the drivers seat, make sure it is adjusted to normal driving position and then look at the line. Mark where the line-of-sight to the line intersects with the bottom of the windshield. Then move the vehicle away from the line the distance you like to drive from the left lane marker (Position 2, illustrated in FIG. 4). This is two to three feet for most drivers. Get back in the drivers seat and mark where the line-of-sight to the line now intersects the bottom of the windshield. Measure the distance between the two marks and then cut the green clear vinyl to that same length and then press the vinyl into place along the bottom edge of the windshield.

2. Move the vehicle so that the driver's side front tire lines up with the line (Position 3, illustrated in FIG. 5). Get back in the driver seat and mark the spot where the line-of-sight to the line now intersects with the bottom of the windshield. Measure the distance from this mark to the first mark and cut the red clear vinyl to the same length and press into place. Next press a narrow blue vinyl strip into place. This strip now locates your driver's side tire. Cut a three-inch red vinyl strip and place next to the blue strip. The red is your warning that you are over the center line.

3. Measure the distance from the left side of the green strip to the edge of the windshield and cut a yellow strip to match. Press into place. This serves as a warning that you may be driving too close to the edge of the road on the right side.

4. Line the passenger side front wheel up with the line (Position 4, illustrated in FIG. 6) and mark the intersection of the line-of-sight from the passenger seat to the line with the bottom of the windshield. Press a narrow blue strip onto the windshield at this mark. Then measure from the blue strip to the outer edge of the windshield and cut a clear green strip to fit and press into place. This will let the passenger know where the wheel is in relationship to the edge of the road. Cut a three inch red strip and press into place.

The green strips now let the driver and the front passenger know the lane position at a glance, thus reducing driving stress. While driving, the center line should be maintained within the green strip, except for passing. If the center line is in the red, the vehicle is over the lane marker. If it is in the yellow, the vehicle may be driving too close to the roadside edge. The guide can be calibrated using, for example, a black marker pen, putting a mark at different distances from the center line. For example, marks may be placed when the vehicle is three feet, two feet, and one foot from the center line. This may not be necessary for most drivers.

Each one of the sheets of the vehicle position indicators may be composed of suitable transparent plastic material, such as vinyl. Each piece may be substantially polygonal in configuration, and may have two opposite marginal edges such as the top and bottom marginal edges parallel to one another. They may be arranged as illustrated in a side-by-side manner to provide a continuous strip. The vinyl film material is clingy and thus is able to be affixed to a portion of the vehicle, such as the windshield 16. It should also be understood that there could be many other types of techniques for affixing the indicator to the windshield or other portion of the vehicle. For example, suitable adhesives, tapes or other techniques may be used. Also, while the device is shown and described to be positioned at the bottom portion of the windshield, other drivers or passengers may find that the device could be applied to the windshield at a higher elevation, depending upon the height or preference of the person. Also, the indicator could be applied or otherwise affixed to other portions of the vehicle, such as outside of the vehicle on the hood or other portions thereof within the field of view of the person seated inside of the vehicle. Also, the image of the indicator or indicators may be projected or reflected onto the windshield or other part of the vehicle.

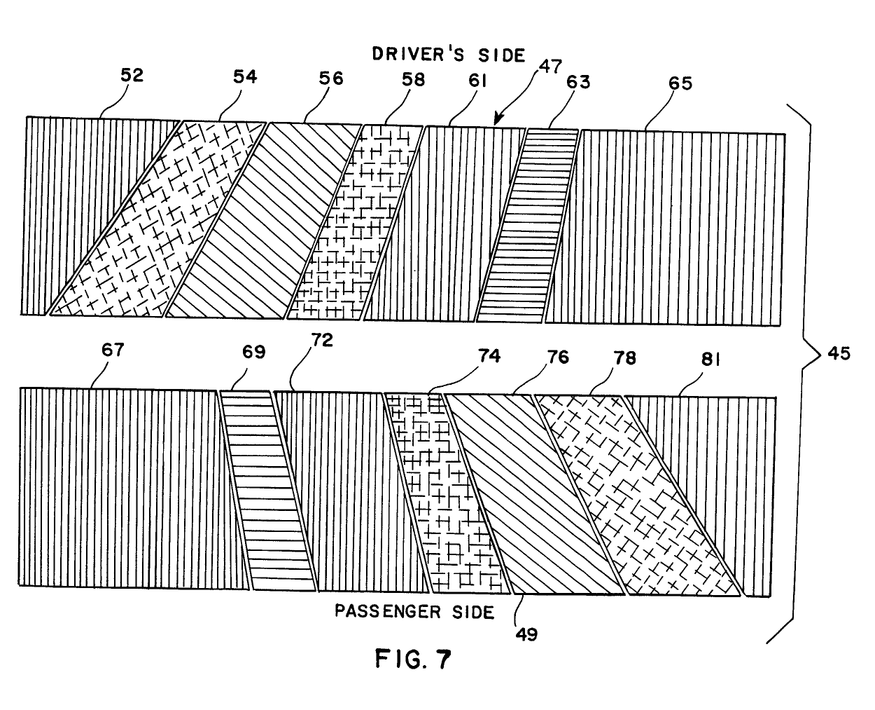

Referring now to FIGS. 7, 8, 9 and 10, there is shown an indicator kit generally indicated as 45 comprising a driver's side vehicle position indicator 47 and a passenger side vehicle position indicator 49. The indicators 47 and 49 are generally similar to the indicators 10 and 12 of FIG. 1, except that they each include a larger number of colored zones to more precisely calibrate the lane markers relative to various portions of the vehicle, such as the inside of the tire, the outside of the tire, the outer body portion and the outside of the side mirror. Additionally, the individual colored zones are not necessarily rectangular in shape.

The indicator 47 comprises 7 colored sheets of plastic material 52, 54, 56, 58, 61, 63 and 65. The passenger side indicator 49 comprises seven colored transparent sheets 67, 69, 72, 74, 76, 78 and 81. It is understood, however, that either greater or fewer number of sheets may be used.

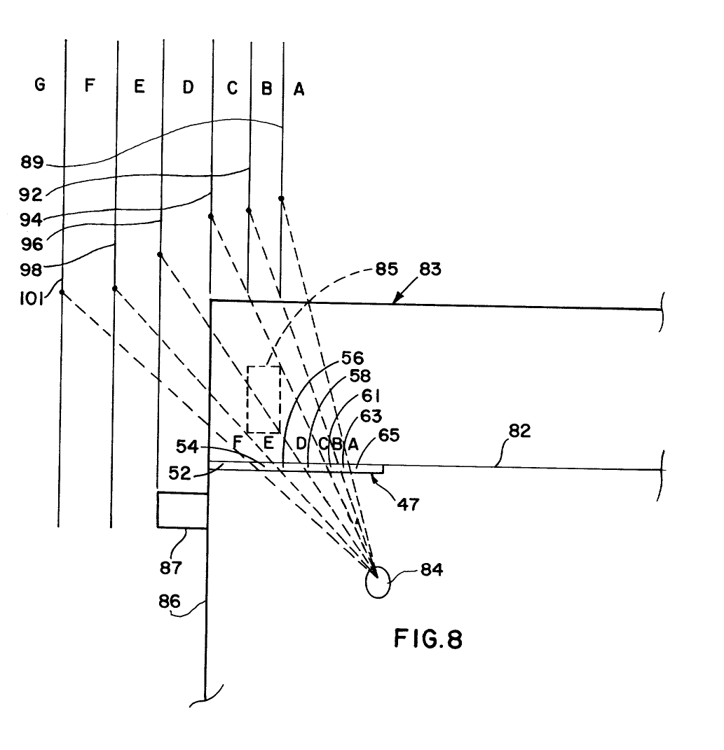

As indicated in FIG. 8, the edges of each sheet of the indicators corresponds to the location of various parts of the vehicle or various points relative to the vehicle such as, for example, the inside and outside of the tire 85, the outermost surface of the driver's side of the vehicle, six feet from the center of the vehicle, or six inches from the outside of the passenger side to the right lane marker (not shown). In this regard, a typical spacing between right-hand left lane markers on a roadway is twelve feet.

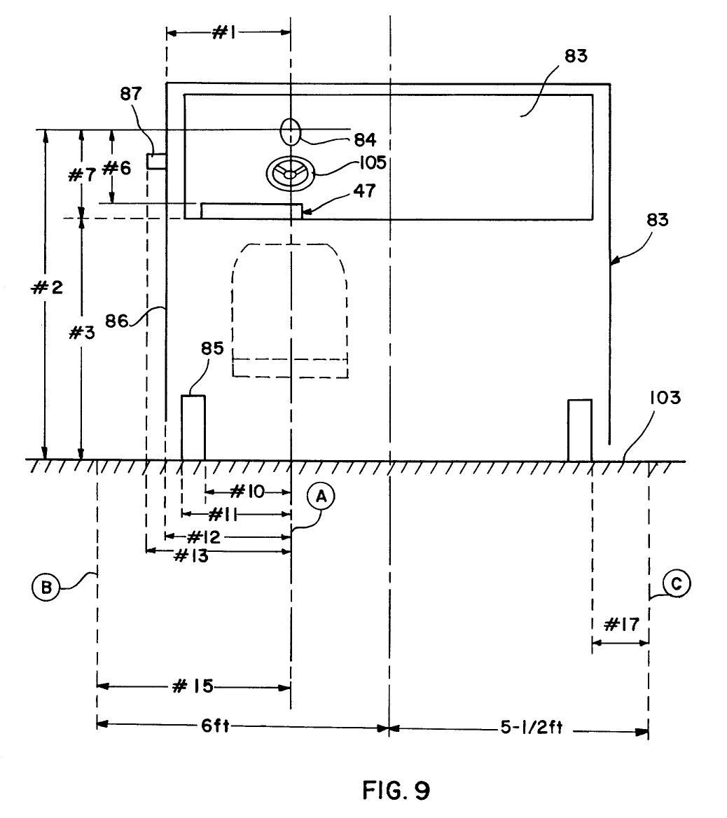

The following example, with reference to FIG. 9, illustrates one method for determining the size of the sheets for each of the indicators 47, 49. The example is accompanied with sample measurements for illustrative purposes only.

For Driver's Side:

| | | | | | |
|---|---|---|---|---|---|
| a. | Measure from the outside of the driver's side to | | 25 | | |
| | the center of the drivers seat. | | | | |
| b. | Measure from the ground to your eye level while | | 86 | | |
| | seated in the drivers seat. | | | | |
| c. | Measure from the ground to the bottom of the | − | 66 | | |
| | windshield. | | | | |
| d. | Subtract “c” from “b”. | = | 20 | | |
| e. | Put in the height of the Lane Safety Locator film | − | 3 | | |
| | (3″) from “d”. | | | | |
| f. | Subtract “e” from “d” | = | 17 | | |
| g. | Divide “d” by “b” (This becomes the bottom | = | .23 | | |
| | factor multiplier.) | | | | |
| h. | Divide “e” by “b” (This becomes the top factor | = | .20 | Times | Times |
| | multiplier.) | | | Bottom | Top |
| i. | Measure from the drivers side of the vehicle | | | Factor | Factor |
| | distance “a”. Place a mark “A” | | | | |
| j. | From mark “A” measure to the inside of the | | 5 | 1.63 | .99 |
| | front tire. | | | | |
| k. | From mark “A” measure to the outside of the | | 13 | 3.02 | 2.57 |
| | front tire. | | | | |
| l. | From mark “A” measure to the outside of the | | 25 | 5.51 | 4.94 |
| | vehicle | | | | |
| m. | From mark “A” measure to the outside of the | | 37 | 8.60 | 7.31 |
| | rear view mirror. | | | | |
| n. | From the center of your vehicle measure six feet | | | | |
| | to the driver's side and place a mark “B” on the | | | | |
| | ground. | | | | |
| o. | From mark “A” measure to mark “B”. | | 47 | 10.93 | 9.29 |
| p. | From the center of your vehicle measure five feet | | | | |
| | six inch to the passenger's side and make a mark | | | | |
| | “C” on the ground. | | | | |
| q. | Measure from the outside of the passenger's side | + | 28 | | |
| | tire to mark “C”. | | | | |
| r. | Add “q” and “o”. | = | 75 | 17.44 | 14.83 |
| s. | Multiply the above numbers by both the bottom | | | | |
| | and top factors. | | | | |
| t. | Take the 3″ high driver's side paper and mark | | | | |
| | the calculated distances. The distances are | | | | |
| | measured from a point on the windshield aligned | | | | |
| | with the center of the driver's seat. Then cut the | | | | |
| | color film to match the segments. The last | | | | |
| | segment is cut to fit. | | | | |

A similar process may be carried out for the passenger side, using the center of the passenger seat as the reference. In one embodiment, the passenger side may require fewer zones and, therefore, fewer measurements.

The driver is not to drive while staring at the film on the windshield, but only to take glances just as one does when using the rear view mirror, side mirror, speedometer and other gauges. The lane marker to the left of the driver should be in the green when in the center of a freeway lane. If the lane marker is in the yellow, it means the mirror is over the line. If the lane marker is in the red zone to the right of the yellow, the side of the vehicle body is over the dividing line. If the lane marker is in the orange, the vehicle is moving into the adjacent passenger lane or off to the side of the road to the right side. If the lane marker is in the red next to the orange, the vehicle is moving off the road or changing lanes to the passenger side. The blue zone gives the driver the location of the wheel and can be very useful when one needs to align the wheel to an object or a line, as is required when pulling up to a hoist or lift.

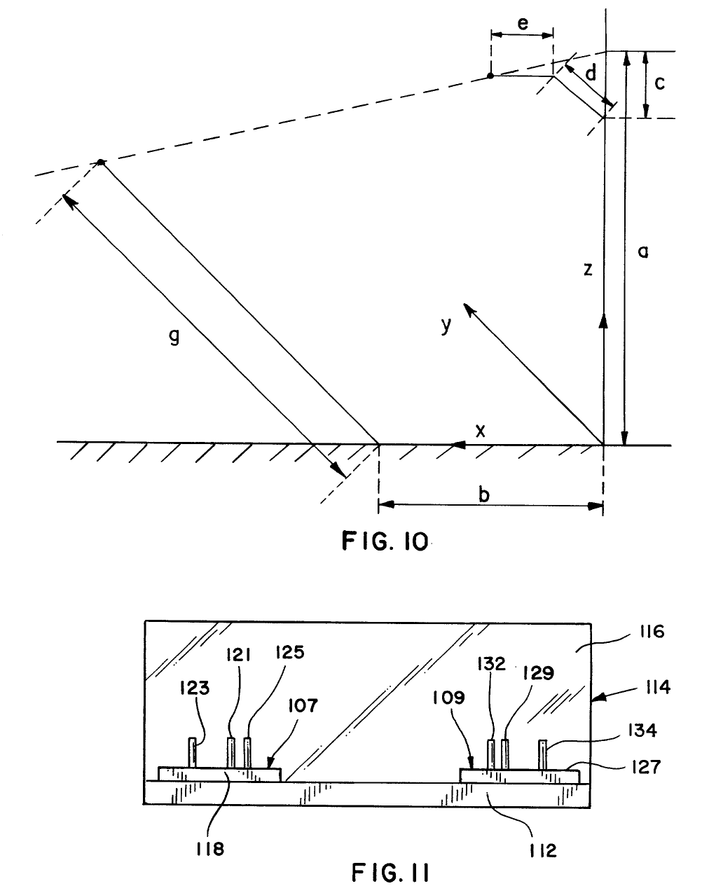

FIG. 10 illustrates the principle of operation of the indicators of the present invention and of measurements relating to the positioning of the indicators, such as those illustrated above with reference to FIG. 9. FIG. 10 illustrates a three-dimensional Cartesian coordinate system. The origin of the coordinate system is located at a point on the ground directly below the eye of the driver. In the coordinate system, the x-axis is directed to the left, the y-axis is directed into the paper (i.e., in the forward direction of the vehicle), and the z-axis is directed upward. The dimension “a” indicates the distance from the ground to the eye of the driver. Thus, the coordinates of the eye of the driver in the three-dimensional coordinate system are (0, 0, a). The line of sight from the eye of the driver to a point on the ground is indicated by the dashed line in FIG. 10. The point on the ground corresponds to the location of various points relative to the vehicle, as illustrated above with reference to FIG. 8. This point on the ground is some distance ahead of the driver looking forward. In FIG. 10, the point is illustrated as being located at a distance “b” in the x direction from the eye of the driver and a distance “g” forward of the eyeball. Thus, the coordinates of this point in the three-dimensional coordinate system are (b, g, 0). The intersection of the line of sight with the vehicle position indicator is also indicated in FIG. 10. In one embodiment, the vehicle position indicator is mounted at the bottom of the windshield of the driver side. Thus, the intersection point corresponds to a point at the bottom of the windshield. In FIG. 10, this point is located at the coordinates (e, d, a-c), where “c” is the distance between the eye of the driver and the bottom of the windshield in the vertical (z) direction, “d” is the distance between the eye of the driver and the windshield in the forward (y) direction, and “e” is the distance between the eye and the windshield in the x direction.

Now, using the coordinates of the eyeball and the coordinates of the intersection point, the equation for the line of sight may be provided in the three-dimensional coordinate system. This equation is:

$$\frac{x}{e} = \frac{y}{d} = \frac{z - a}{- c}$$

Evaluating this equation at the reference point on the ground yields the following relationship:

$$\frac{b}{e} = \frac{g}{d} = \frac{- a}{- c}$$

$$or$$

$$\frac{a}{c} = \frac{b}{e}$$

From this equation, it may be concluded that the relationship between the distances “b” and “e” is identical to the relationship between the distances “a” and “c.” Thus, by measuring the distances in the x direction, as done above with reference to FIG. 9, the reference point on the ground may be properly aligned with a point on the windshield or with a point on the vehicle position indicator.

Referring now to FIG. 11, there is shown another embodiment of the vehicle position indicators 107 and 109 which are adapted to be positioned on the top surface of a dashboard 112 of a vehicle 114 having a windshield 116. The indicator 107 includes a base 109 having a series of upstanding indicator rods, such as an indicator rod 121 which serves to provide or define two indicating zones disposed in the user's field of view when positioned within the vehicle 114 for sighting an external reference (not shown) to facilitate determining the position of the vehicle 114 relative to the external reference. In this manner, the vehicle can be guided in a desired path of travel relative to the reference. A part of the outer indicator rods 123 and 125 defines the outer limits of the two zones. The indicating rods are adapted to be affixed movably to the base 109, which in turn is affixed to the dashboard 112 of the vehicle 114. One manner in which they can be movably attached to the base 109 is by the base 109 being magnetized and the indicating rods being composed of magnetic materials such as steel. In this manner, the indicating rods can be readily moved to an adjusted position to accommodate different users within the vehicle.

Similarly, the indicator 109 is similar to the indicator 107, and includes a base 127 and a set of 3 upstanding indicator rods 129, 132 and 134.

In another embodiment, the indicators protrude downward from a sun visor above the windshield in front of the driver's and passenger's seats. The indicators may be made of a clear plastic material with movable lines to define the zones described above.

The invention is not limited for uses in land vehicles. As an example, the pilot of a small airplane may use the invention to align his airplane on a narrow runway during a landing attempt. The indicators may be calibrated, for example, for a certain altitude. When the pilot reaches that altitude, he can ensure proper alignment with the runway.

The invention, therefore, provides a driving aid to assist the driver or the passenger to accurately determine the position of the vehicle on the road and, if needed, make the appropriate adjustments. The driving aid according to the invention defines, for example, safe and danger zones in which a lane marker may appear. The aid may be in the form of members which divide the various zones. These members may be substantially vertical lines on a transparent strip, for example. In one embodiment, the members may be lines which are etched into the windshield of a vehicle at the point of manufacture or may be members which themselves represent zones. Alternatively, the members may be surfaces which define one or more substantially horizontal zones. As illustrated in the above examples, a member could define a safe green zone. In other embodiments described above, a member could comprise several zones.

Thus, a driving aid has been described according to the present invention. Many modifications and variations may be made to the techniques and structures described and illustrated herein without departing from the spirit and scope of the invention. Accordingly, it should be understood that the embodiments described herein are illustrative only and are not limiting upon the scope of the invention.

What is claimed is:

1. A vehicle position indicator, comprising:
at least one member defining at least two indicating zones disposed in the user's field of view positioned at the vehicle for siting an external reference to facilitate determining the position of the vehicle relative to the external reference so that the vehicle can be guided in a desired path of travel relative to the reference;
said member including at least one indicia separating said zones; and
said member being adapted to be fixed to a portion of the vehicle in front of the vehicle at one side thereof for either the driver or the passenger to use.

2. A vehicle position indicator according to claim 1, wherein said at least one member includes at least two colored transparent sheets.

3. A vehicle position indicator according to claim 2, wherein each one of said sheets is generally rectangular in configuration.

4. A vehicle position indicator according to claim 2, wherein said sheets are each composed of suitable film material.

5. A vehicle position indicating kit, comprising:
a pair of vehicle position indicators, each one of said indicators including at least one member defining at least two indicating zones disposed in the user's field of view positioned at the vehicle for siting an external reference to facilitate determining the position of the vehicle relative to the external reference so that the vehicle can be guided in a desired path of travel relative to the reference;
said member including at least one indicia separating said zones; and
said number being adapted to be fixed to a portion of the vehicle in front of the vehicle at one side thereof for either the driver or the passenger to use.

6. A method of installing a vehicle position indicator on a vehicle, comprising:
providing the indicator;
positioning the vehicle adjacent to an external reference;
aligning the indicator within the field of view of the user positioned within the vehicle to sight the external reference to define a position for locating the indicator on the vehicle; and
affixing said indicator to the vehicle at the position.

7. A method according to claim 6, wherein the step of aligning includes cutting individual differently colored sheets of colored transparent film and disposing them in a side-by-side relationship on the inside of the windshield of the vehicle.

8. A vehicle position indicator for aiding in positioning of a vehicle, comprising:
a strip of film mounted in front of a vehicle occupant;
said strip having one or more side-by-side zones, each zone corresponding to a region relative to said vehicle.

9. A vehicle position indicator, comprising:
at least one member defining at least one indicating zone disposed in the user's field of view positioned at the vehicle for sighting an external reference to facilitate determining the position of the vehicle relative to the external reference so that the vehicle can be guided in a desired path of travel relative to the reference;
said member including at least one indicia demarcating said zone; and
said member being adapted to be affixed to a portion of the vehicle in front of the vehicle at one side thereof for either the driver or the passenger to use.

10. A vehicle position indicator according to claim 9, wherein said at least one member is a sheet of transparent film.

11. A vehicle position indicator according to claim 10, wherein said sheet is generally rectangular in configuration.

12. A vehicle position indicator according to claim 10, wherein said film is colored for each zone.
